(19) United States
(12) Patent Application Publication
(10) Pub. No.: US 2023/0126602 A1
(43) Pub. Date: Apr. 27, 2023

(54) FOLDING PET STAIRCASE

(71) Applicant: EZRA INNOVATION LIMITED, Kowloon (HK)

(72) Inventor: Eric Kong, Kowloon (CN)

(21) Appl. No.: 17/553,755

(22) Filed: Dec. 16, 2021

(30) Foreign Application Priority Data
Oct. 27, 2021 (CN) 202122595108.8

(51) Int. Cl. E04F 11/06; A01K 1/035

(52) U.S. Cl. CPC E04F 11/066; A01K 1/035

(57) ABSTRACT

A folding pet staircase consists of frames and treads, wherein, the frame comprises a starting edge, a tread edge and side edges, two sides of the starting edge are connected with the side edges, two sides of the tread edge are connected with the side edges, a tread beam is arranged between the starting edge and the tread edge, baffle fixing plates are embedded in the starting edge, the tread edge and the side edges, and the tread is placed on the tread beam. The fixing plates are fixed to the specific positions by the flexible fabric frames. When the user wants to fold the pet staircase, he/she can fold the pet staircase directly along the crease lines of the fixing plates into a flat sheet structure, thus facilitating storage. The pet staircase can be used for the storage of small pet products such as toys, comb, snacks, etc.

### CROSS REFERENCE TO RELATED APPLICATION

This application claims priority benefit of Chinese Patent Application No. 202122595108.8, filed on Oct. 27, 2021, and the entire contents of which are incorporated herein by reference.

### TECHNICAL FIELD

The present disclosure relates to a pet staircase, in particular to a folding fabric pet staircase which can be folded into a sheet.

### BACKGROUND

With the improvement of people's living quality, more and more families choose to raise pets. In order to facilitate small sized pet dog or cats to move back and forth between high and low activity spaces or in the uneven outdoor environment, pet staircases specially for pets have appeared on the market.

Most of the pet staircases on the market adopt fixed structure, which are placed beside sofas, windows or beds which occupy large area of space and can only be used as staircases. When the users dissemble them or need to take them outdoors, it takes up a lot of space to store them for use, and they can only be used as staircases, lacking practicality.

### SUMMARY

The present disclosure aims to provide a folding pet staircase. The fixing plates are fixed to the specific positions by the flexible fabric frames. When the user wants to fold the pet staircase, he/she can fold the pet staircase directly along the crease lines of the fixing plates into a flat sheet structure, thus facilitating storage.

A folding pet staircase, wherein staircase consists of frames 1 and treads 2, wherein, the frame 1 comprises a starting edge 11, a tread edge 12, a plurality of side edges 13 and a back plate edge 15, the side edges 13 are arranged between two sides of the starting edge 11 and two sides of the tread edge 12, the side edges 13 are arranged between two sides of the tread edge 12 and two sides of the back plate edge 15, a tread beam 14 is arranged between the starting edge 11 and the tread edge 12, a tread beam 14 is arranged between the tread edge 12 and the back plate edge 15, baffle fixing plates 151 are embedded in the starting edge 11, the tread edge 12 and the back plate edge 15, a front side edge fixing plate 1311 and a rear side edge fixing plate 1321 are embedded in the side edges 13, the front side edge fixing plate 1311 has the same size as the rear side edge fixing plate 1321, the tread 2 is placed on the tread beam 14, creases 133 are arranged among the starting edge 11, the side edge 13, the tread edge 12, the side edge 13 and the back plate edge 15, the crease 133 is arranged in the middle of the side edge 13 and positioned between the front side edge fixing plate 1311 and the rear side edge fixing plate 1321, and the side edge 13 is divided into a front side edge 131 and a rear side edge 132 by the crease 133.

The side edges 13 are arranged between two sides of the starting edge 11 and two sides of the tread edge 12, and connected with the starting edge 11 to form a U shape. The side edges 13 are arranged between two sides of the tread edge 12 and two sides of the back plate edge 15 and connected with the tread edge 12 to form a U shape, thereby forming a structure where the tread 2 can be placed.

The corresponding fixing plates are embedded into the areas divided by the crease 133 on the frame 1, and the crease 133 plays a role of a structure capable of folding and laying the fixing plates flat when the pet staircase is folded.

Wherein, the connections between the starting edge 11 and the side edge 13 and between the starting edge 11 and the tread edge 12 form an inner cavity space, and the user can use the space as a storage box to store items, so as to extend the practicality of the present disclosure.

Preferably, one side of the tread 2 is a plush surface or other fabric surface, and the other side is a flat surface. The tread 2 with two different surfaces aims to meet different needs of the tread 2 in different environments.

Preferably, the frame 1 is provided with an edge wrapped on the top of the starting edge 11 and the side edge 13, the edge is U-shaped, and the tail of the edge is not in contact with a tread edge 12. The bottom of the edge is flush with the tread beam 14.

Preferably, a baseplate fixing plates 152 are installed at the bottom of the starting edge 11, the tread edge 12 and the side edge 13. The baseplate fixing plates 152 can be put from the gap between the side edge 13 and the tread beam 14 and installed at the bottom of the starting edge 11, the tread edge 12 and the side edge 13 and at the bottom of the tread edge 12, the side edge 13 and the back plate edge 15; or a cavity with an opening downward is arranged at the bottom of the starting edge 11, the tread edge 12 and the side edge 13, a cavity with an opening downward is arranged at the bottom of the tread edge 12, the side edge 13 and the back plate edge 15, and the baseplate fixing plates 152 are directly installed to the cavity from bottom to top.

### BRIEF DESCRIPTION OF THE DRAWINGS

FIG. 1 is a exploded view for a folding pet staircase of the present disclosure.

FIG. 2 is a stereogram for the frame 1 of a folding pet staircase of the present disclosure.

FIG. 3 is a side view for the frame 1 of a folding pet staircase of the present disclosure after folding.

FIG. 4 is a bottom view for the frame 1 of a folding pet staircase of the present disclosure after folding.

FIG. 5 is a rear view for a folding pet staircase of the present disclosure.

FIG. 6 is a right view for a folding pet staircase of the present disclosure.

FIG. 7 is a upward view for a folding pet staircase of the present disclosure.

### DESCRIPTION OF THE EMBODIMENTS

The following is a further detailed description of the present disclosure in combination with the drawings.

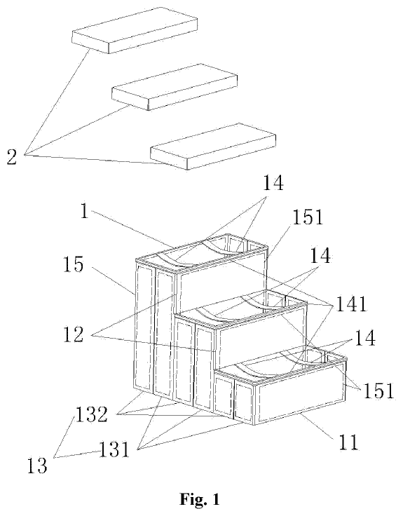

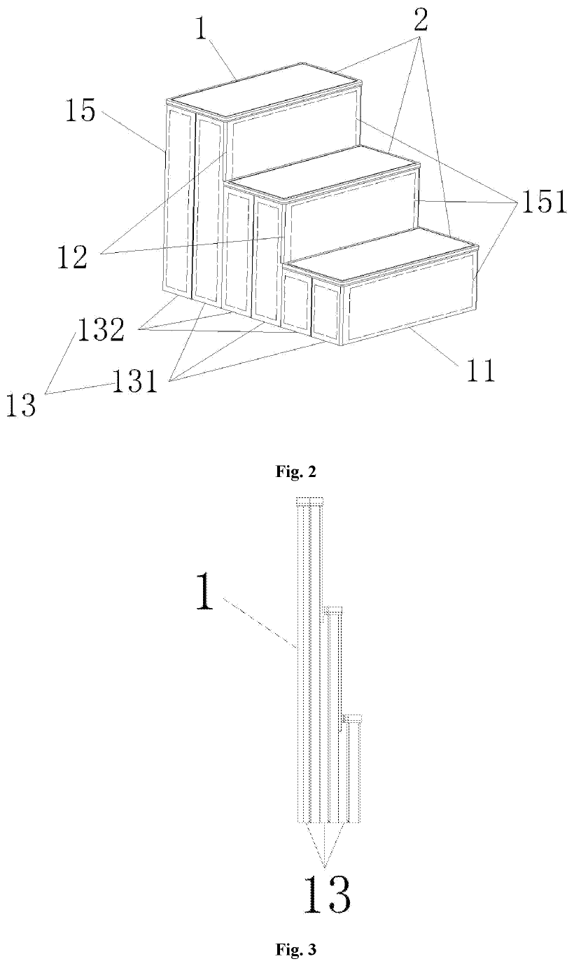

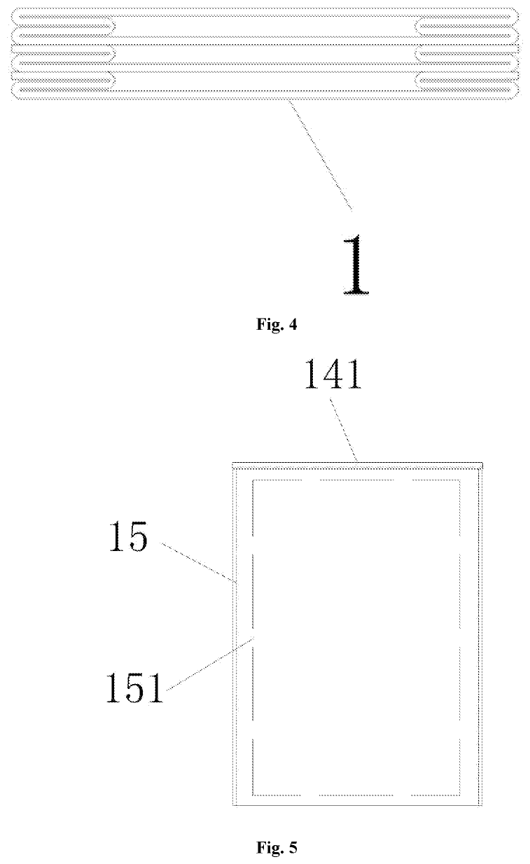

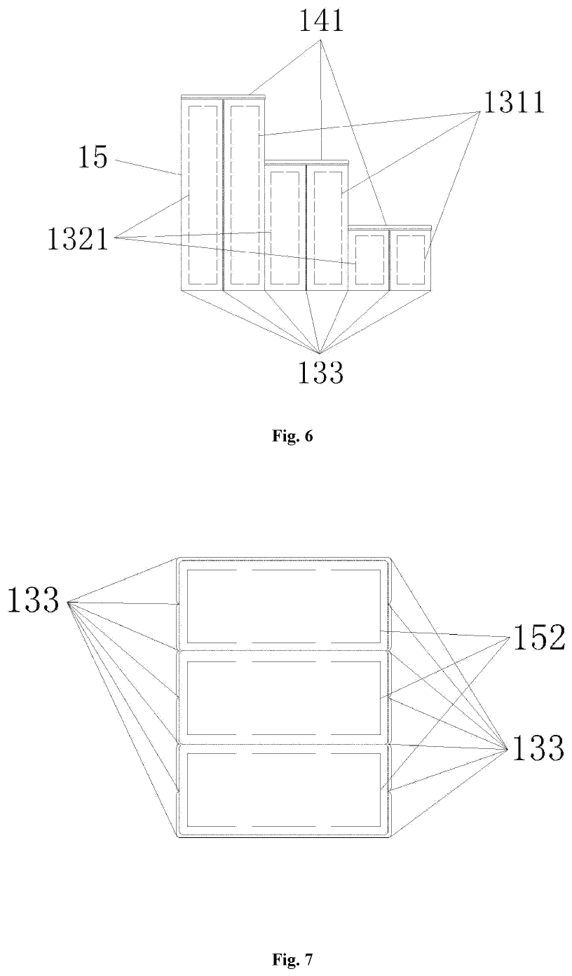

Refer to FIG. 1, FIG. 2, FIG. 3, FIG. 4, FIG. 5, FIG. 6 and FIG. 7: when the user wants to disassemble and fold a folding pet staircase of the present disclosure, he/she can directly remove the tread 2, then remove the baseplate fixing plates 152 at the bottom of the starting edge 11, the tread edge 12, the side edge 13 and at the bottom of the tread edge 12, the side edge 13 and the back plate edge 15 to dismount the fixing structure of the frame 1, and then fold the side edge to the outside or inside, so that the front side edge 131 and the rear side edge 132 are folded together, then the pet staircase can be transformed into a flat sheet shape for easy storage.

Refer to FIG. 1. The frame 1 can be made of linen and other common wear-resistant, soft, elastic and folding fabrics, aiming to secure the position of the fixing plates which form the structure of the pet staircase and ensure the bending and folding durability of the creases 133 when the pet staircase is folded.

The number of stairs of the pet staircase can be one, two or more. A tread beam 14 is arranged between the starting edge 11 and the tread edge 12, and a tread beam 14 is arranged between the tread edge 12 and the backplate edge 15. The tread beams 14 can change with the shape change of the frame 1. When the frame 1 is folded, the tread beam 14 is folded to the center by the starting edge 11 and the tread edge 12 or the tread edge 12 and the backplate edge 15 on both sides. When unfolded, the frame 1 is straightened back and forth to form a beam structure supporting the tread 2. The fixing plates embedded in the frame 1 can be corrugated boards, wood boards, iron plates or other common boards. The front side edge fixing plate and the rear side edge fixing plate are embedded in the side edges 13, the front side edge fixing plate 1311 has the same size as the rear side edge fixing plate 1321, the front side edge fixing plate 1311 and the rear side edge fixing plate 1321 are rectangles that are the same size, namely, the side edge 13 is divided into the front and rear areas with the same size by the fixing plate, and the crease 133 arranged in the center of the side edge 13 ensures that the side edge can be folded along the crease 133 when the frame 1 is folded.

The corresponding fixing plates are embedded into the areas divided by the crease 133 on the frame 1, and the crease 133 plays a role of a structure capable of folding and laying the fixing plates flat when the pet staircase is folded.

Wherein, the connections between the starting edge 11 and the side edge 13 and between the starting edge 11 and the tread edge 12 form an inner cavity space, and the user can use the space as a storage box to store items, so as to extend the practicality of the present disclosure.

The tread 2 integrates the functions of stair pedal and storage box cover plate, which is convenient for the use of the pet staircase. In addition, the tread 2 can be a tread cover embedded with a hard plate for fixing the shape, which facilitates removal and cleaning; the tread 2 can also be an integrated design of tread cover and hard plate to prevent the occurrence of losing items during removal and installation.

The tread 2 has a plush surface or other fabric on one side and a flat surface on the other side, which is an embodiment of the present disclosure. The user can change the orientation of the tread 2 arranged on the tread beam 14 to change the material of the tread 2, so that the pet can move on the most suitable tread 2 and extend the practicality of the tread 2.

The frame 1 is provided with a U-shaped edge wrapped on the top of the starting edge 11 and the side edge 13, which is an embodiment of the present disclosure. The edge not only constitutes the wrapping structure of the frame 1 to protect its edge, and actually the edge of the frame 1 is thickened. When the tread 2 is installed, the edge can grasp the periphery of the tread 2 under the combined action of the thickened structure and the elastic frame 1, thereby ensuring the edge is not loosened easily when the tread 2 is in use.

The baseplate fixing plates are installed at the bottom of the starting edge 11, the tread edge 12 and the side edge 13, which is an embodiment of the present disclosure. One end of the baseplate fixing plate 152 is also connected with the starting edge 11 or the tread edge 12 by fabric stitching. When the pet staircase is required to be folded, the baseplate fixing plates 152 can be folded towards the starting edge 11 or the tread edge 12, so that the baseplate fixing plates 152 can be stored.

In addition to the convenient folding function, the pet staircase can be packaged into a smaller structure to be transported to the customers after being sold by factories or stores, greatly reducing transportation costs.

The above embodiments are only the preferred embodiments of the present disclosure. It should be noted that ordinary technicians can make a number of variants and improvements on the premise of not deviating from the creative idea of the present disclosure, which belong to the protection scope of the present disclosure.

What is claimed is:

1. A folding pet staircase, wherein consists of frames (1) and treads (2), wherein, the frame (1) comprises a starting edge (11), a tread edge (12), a plurality of side edges (13) and a back plate edge (15), the side edges (13) are arranged between two sides of the starting edge (11) and two sides of the tread edge (12), the side edges (13) are arranged between two sides of the tread edge (12) and two sides of the back plate edge (15), a tread beam (14) is arranged between the starting edge (11) and the tread edge (12), a tread beam (14) is arranged between the tread edge (12) and the back plate edge (15), baffle fixing plates (151) are embedded in the starting edge (11), the tread edge (12) and the back plate edge (15), a front side edge fixing plate (1311) and a rear side edge fixing plate (1321) are embedded in the side edges, the front side edge fixing plate (1311) has the same size as the rear side edge fixing plate (1321), and the tread (2) is placed on the tread beam (14); the starting edge (11), the side edge (13), the tread edge (12), the side edge (13) and the back plate edge (15) are connected in sequence and creases (133) are arranged at the connections, the crease (133) is arranged in the middle of the side edge and positioned between the front side edge fixing plate (1311) and the rear side edge fixing plate (1312), and the side edge (13) is divided into a front side edge (131) and a rear side edge (132) by the crease (133).

2. The folding pet staircase according to claim 1, wherein one side of the tread (2) is a plush surface, and the other side is a flat surface.

3. The folding pet staircase according to claim 1, wherein the frame (1) is provided with an edge (141) on the top of the starting edge (11) and the side edge (13), the edge (141) is U-shaped, and the tail of the edge (141) is not in contact with the tread edge (12).

4. The folding pet staircase according to claim 1, wherein a baseplate fixing plate (152) is installed at the bottom of the starting edge (11), the tread edge (12) and the side edge (13), and a baseplate fixing plate (152) is installed at the bottom of the tread edge (12), the side edge (13) and the back plate edge (15).
